(19) United States
(12) Patent Application Publication
(10) Pub. No.: US 2011/0226950 A1
(43) Pub. Date: Sep. 22, 2011

(54) LINEAR MOTOR PAIR, MOVING STAGE AND ELECTRON MICROSCOPE

(75) Inventors: Hideki TANAKA, Hitachinaka (JP); Tsuyoshi Wakuda, Hitachinaka (JP)

(73) Assignee: Hitachi, Ltd.

(21) Appl. No.: 13/032,984

(22) Filed: Feb. 23, 2011

(30) Foreign Application Priority Data
Mar. 17, 2010 (JP) 2010-060062

(51) Int. Cl. H01J 3/38; H02K 41/03

(52) U.S. Cl. 250/311; 310/12.06

(57) ABSTRACT

When using a moving magnet type linear motor pair for a moving stage, the magnetic field in a space defined by the linear motor pair varies greatly in association with the movement of movable bodies. For this reason, 4N sets (N is a natural number) of magnet pairs 12 are disposed in mirror symmetry with reference to the center plane of a movable body 3 for a linear motor. The magnet pairs 12 are arranged in such a manner that the polarities of the adjoining pair at the center line 19 of the movable body are set same and the polarities thereof are set to alternate as in an N pole and a S pole according to when the pairs move away from the center. When a linear motor pair is formed by disposing two sets of such linear motors in parallel, and with this linear motor pair a stage is driven, the magnetic field variation in the space defined by the linear motor pair caused in association with the movement of movable bodies is suppressed. When such linear motor pair is utilized in a moving stage, for example, for an electron microscope and the like, a highly accurate electron beam image is observable.

### CLAIM OF PRIORITY

The present application claims priority from Japanese application serial No. 2010-060062, filed on Mar. 17, 2010, the contents of which is hereby incorporated by references into this application.

### FIELD OF THE INVENTION

The present invention relates to a linear motor pair in which two sets of linear shaped stationary bodies are disposed in parallel, and further relates a moving stage and an electron microscope using such linear motor pair.

### DESCRIPTION OF PRIOR ART

As disclosed, for example, in JP-A-8-37772, a linear motor that causes to move a movable body linearly includes a moving magnet type linear motor which comprises a group of permanent magnets at the movable body side and a group of coils at the stationary side. Further, a moving coil type linear motor is also used in which combination between the moving body and the stationary body is replaced. The position of the movable body is controlled in both types by controlling current flowing through the group of coils.

Since a highly accurate positioning can be performed with such linear motor, the linear motor has been used as a driving device for a moving stage that moves two dimensionally in apparatus requiring a highly accurate positioning.

When a linear motor is utilized as a stage driving device for an electron microscope, a possible dust generation caused in association with changes in position or shape of current flowing wirings is regarded as problematic in a case of the above referred to moving coil type linear motor. On the other hand, in a case of the moving magnet type linear motor, since the group of coils is fixed, no changes in position and shape of such as wirings and pipings are caused in association with the movement of the movable body.

In FIG. 1, an example is shown when a moving magnet type linear motor to which the present invention is applied is used for driving a stage. FIG. 1 is a schematic cross sectional view. The moving direction of a movable body 3 constituted by permanent magnets 1 and a yoke 2 is in a direction perpendicular to the plane of the drawing. The permanent magnets 1 are disposed spaced apart with a predetermined interval in a manner so as to face an N pole to a S pole thereof each other, and are further arranged along the moving direction of the movable body 3 in a manner so as to switch an N pole and a S pole thereof alternatively and are fixedly secured to the yoke 2. A group of coils is included in a stationary body 4. The movable body 3 is connected to a moving stage 5 such as via a coupling portion 6. In the present example, although the both are connected directly, the both are sometimes connected indirectly. Further, the movable body 3 is supported by a support device 7 for limiting such as friction resistance. The support device 7 includes such as a linear guide having a limited friction and a floating support device that utilizes compressed air.

In FIG. 2, an example of a driving stage for an electron microscope to which the present invention is applied is shown. As shown in the drawing, both x axis and y axis are provided with a linear motor pair each constituted by two moving magnet type linear motors. Through controlling the position of movable bodies 3, the position of a sample (not shown) fixedly secured on a moving stage 5 is also changed. Since an irradiation position 8 of electron beams and the irradiation region thereof are substantially fixed, when the sample is positioned at the electron beam irradiation region by driving the moving stage 5 in advance and when scanning the electron beams or microscopically moving the stage, an imaging of the sample at a desired x and y coordinate positions is enabled.

However, since the relative distance between the electron beam position 8 and the movable body 3 changes, the magnetic field near the electron beam position 8 varies (herein below will be called as magnetic field variation) in association with the movement of the movable body 3, which makes a highly accurate imaging difficult. This is because the orbits of the electron beams delicately vary due to the magnetic field variation.

In order to prevent the above, when suppressing a leakage magnetic field distribution from the movable body 3 by arranging a magnetic shield around the movable body 3, it is possible to reduce the magnetic field variation to some extent. Further, it is also possible to suppress the magnetic field variation to a level of microtesla, when disposing a plurality number of magnetic shield sheets, however, in a case of Critical Dimension—Scanning Electron Microscope (CD-SEM) and the like having a limited allowable magnetic field variation, even a magnetic field variation of microtesla level is problematic.

On one hand, in FIG. 3, an arrangement example of permanent magnets as is known such as from JP-B-2-3393 is shown. The drawing is a cross sectional view taken in horizontal direction. Permanent magnets in a group are disposed spaced apart with a predetermined interval in a manner so as to face an N pole to a S pole thereof each other, and are further arranged along the moving direction 9 of a movable body in a manner so as to replace an N pole and a S pole thereof alternatively and are fixedly secured to the yoke 2. In order to simplify the explanation herein, a permanent magnet in which a S pole is at up side and an N pole is at down side in the drawing is called as a downward directing permanent magnet 10, an opposite thereof as an upward directing permanent magnet 11 and two facing permanent magnets while sandwiching a stationary body 4 therebetween as “a magnet pair” 12.

When the number of the magnet pairs 12 is an even number as in the example as shown in the drawing, since the number of the upward directing permanent magnets and the downward directing permanent magnets is equal, the magnetic fields caused by both upward and downward directing permanent magnets seem to be cancelled out each other. However, magnetic poles of N, S, N, S were found out appearing at the corners of the movable body as shown in the drawing, because the magnetic fluxes being generated by the permanent magnets at both ends in the moving direction of the movable body are directed outside.

### SUMMARY OF THE INVENTION

Herein, influences and the like of the magnetic poles that appear at the corners of the movable body as mentioned in connection with FIG. 3 will be explained with reference to FIGS. 4 and 5.

FIG. 4 shows an example when a driving stage in x axis direction is constituted by making use of a linear motor pair mounting the movable body as shown in FIG. 3. The present example is an example in which magnetic poles of different polarities are faced each other between two movable bodies constituting the linear motor pair. In this instance, magnetic fluxes 13 direct as in the arrows 13. A magnetic field evaluation point 14 corresponds to an electron beam position of an electron microscope and locates at a middle point of the linear motor pair. When moving the two movable bodies 3 in x direction while coupling both, x components 18 of the magnetic field are cancelled out at the magnetic field evaluation point 14. However, y components 16 of the magnetic field are strengthened mutually, and the distribution thereof indicates in such a manner that the component gives zero when the movable bodies are disposed at the front of the magnetic field evaluation point (the position of movable bodies is at 17 on x coordinate) and gives plus values and minus values from the zero point as shown in FIG. 4.

On the other hand, in FIG. 5, an example of constituting a driving stage in x axis direction is shown in which magnetic poles having same polarity are faced between the two movable bodies. In this instance, y components 16 of the magnetic field are cancelled out at the magnetic field evaluation point 14, however, the x components 18 of the magnetic field are strengthened mutually, and the distribution thereof indicates in such a manner that the component maximizes when the movable bodies are disposed at the front of the magnetic field evaluation point and becomes small in association with the movement thereof.

Namely, when the number of the magnet pairs included in the movable bodies is even number, the magnetic field variation at a middle point in a linear motor pair is necessarily strengthened mutually at any one of in moving direction of the movable bodies and in the direction toward the other movable body. On the other hand, when the number of the magnet pairs is an odd number, since the number of the downward directing permanent magnets 10 and that of the upward directing permanent magnets 11 are not equal, leakage magnetic field from the movable bodies further increases in comparison with when the number of the magnet pairs is an even number.

Accordingly, an object of the present invention is to provide a moving magnet type linear motor pair that suppresses magnetic field variation caused in association with movement of the movable bodies and thereby limits influences to magnetic field environment, and further to provide a moving stage and an electron microscope.

In order to achieve the above object, a feature of the present invention is to provide 4N (N is a natural number) sets of magnet pairs for respective movable bodies constituting a moving magnet type linear motor pair along moving direction thereof, to dispose the 4N sets of magnet pairs in mirror symmetry with reference to the center portion in the moving direction of the movable bodies as well as to adjoin magnets having a same polarity at the center portion in the moving direction and to arrange an N pole magnet and a S pole magnet alternatively in accordance with being away from the center portion.

Further, another feature of the present invention is to arrange the polarities of the magnetic poles of the 4N sets of magnetic pairs in the linear motor pair so that if the both movable bodies are overlapped the polarities of the magnetic poles thereof coincide each other, and to constitute a moving stage and further an electron microscope by making use such linear motor pair.

### EFFECTS OF THE INVENTION

According to the present invention, since the magnetic field variation caused by the movement of the movable bodies constituting a linear motor pair can be suppressed, thereby, a linear motor pair, a moving stage and further an electron microscope that limit influences to magnetic field environment can be realized.

### BRIEF DESCRIPTION OF THE ACCOMPANYING DRAWINGS

FIG. 1 is a schematic cross sectional view of a moving magnet type linear motor to which the present invention is applied.

FIG. 2 is a diagram of an embodiment of a driving stage for an electron microscope to which the present invention is applied.

FIG. 3 is an arrangement diagram of permanent magnets in a conventional movable body.

FIG. 4 is a view for explaining magnetic field variation caused in association with movement of a movable body.

FIG. 5 is another view for explaining magnetic field variation caused in association with movement of a movable body.

FIG. 6 is a cross sectional view of an embodiment 1 of a movable body according to the present invention.

FIG. 7 is a diagram of uniaxial drive mechanism of the embodiment 1 according to the present invention.

FIG. 8 is a cross sectional view of an embodiment 2 of a movable body according to the present invention.

FIG. 9 is a cross sectional view of a comparison of a movable body.

FIG. 10 is magnetic field distribution graphs of the embodiment 2 according to the present invention and of the comparison.

FIG. 11 is a cross sectional view of an embodiment 3 of a movable body according to the present invention and a diagram of magnetic flux density distribution in gap.

FIG. 12 is a cross sectional view of an embodiment 4 of a movable body according to the present invention and a diagram of magnetic flux distribution therein.

FIG. 13 is a cross sectional view of an embodiment 5 of a movable body according to the present invention.

FIG. 14 is a cross sectional view of an embodiment 6 of a movable body according to the present invention.

### DETAILED DESCRIPTION OF PREFERRED EMBODIMENTS

Herein below, manners of embodying the present invention will be explained with reference to embodiments as illustrated. Although objects and features of the present invention other than the above are disclosed in the embodiments, these features and effects will be explained at respective occasions.

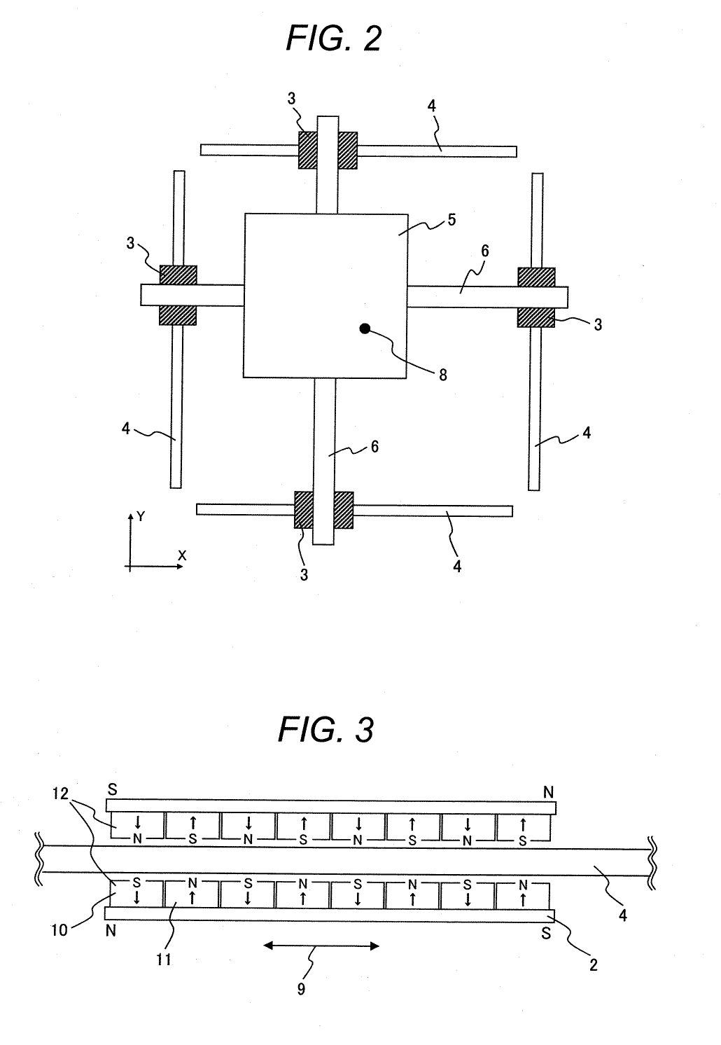

Further, in the embodiments that will be explained herein below, although a portion of a movable body of linear motor pairs representative of the feature of the present invention will in particular be explained primarily, a moving stage, an electron microscope and the like making use of these linear motor pairs can be easily practiced from the constitution as shown in FIG. 2. Further, the use of the present invention that suppresses the magnetic field variation is not limited to the electron microscope, but the use thereof is known to be applicable for a drawing device making use of electron beams, a processing device for such as semiconductors that makes use of an ion gun and the like, and the like effects can be achieved when the present invention is applied to these devices.

### Embodiment 1

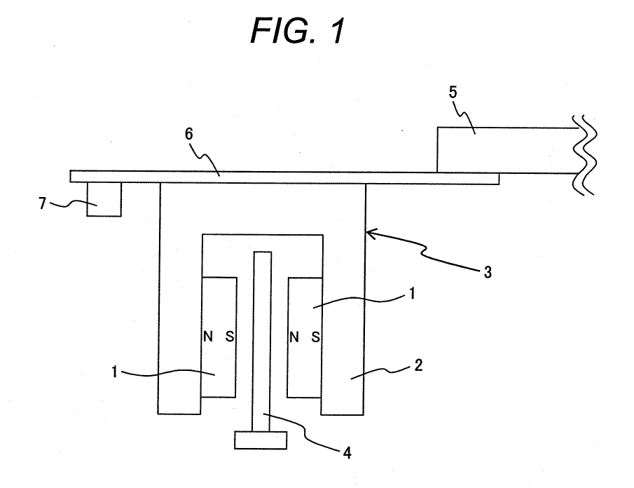

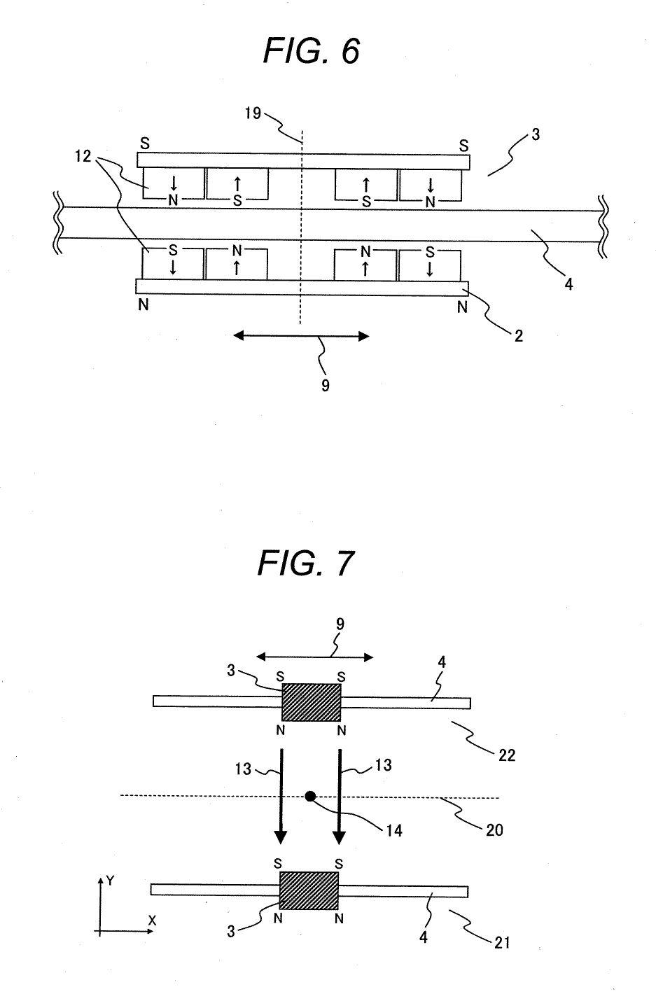

FIGS. 6 and 7 show an embodiment of the present invention. FIG. 6 is a cross sectional view in horizontal direction of a movable body 3. The movable body 3 is primarily constituted by a plurality of permanent magnets 1 and a yoke 2. A magnet pair 12 is constituted by disposing two permanent magnets having substantially the same size and substantially the same magnetic flux density while being spaced apart with a predetermined interval in a manner that an N pole thereof faces a S pole thereof. 4N (N is a natural number) sets of the magnet pairs 12 are disposed in mirror symmetry with reference to the center plane 19 of the movable body. However, the polarity of the permanent magnets 1 is arranged in a manner that an N pole and a S pole alternate along a moving direction 9 of the movable body except for the portion where the center line 19 of the movable body is crossed. Although a case of four sets of magnet pairs 12 is shown in the present embodiment, an arrangement of such as eight sets and twelve sets is also possible. These permanent magnets 1 are fixedly secured to the yoke 2 produced from a material such as iron having a large permeability. The shape of the yoke 2 is preferable to be a C shape of which opening is directed downward as shown in FIG. 1 or a horseshoe shape.

A stationary body 4 is disposed in a gap between the magnet pair 12. A plurality of coils (not shown) that are arranged substantially along a straight line are disposed in the stationary body 4, and the movable body 3 is caused moved by controlling the current flowing through the coils. With regard to such as the shape and arrangement of the coils and the current flow control, since a conventional constitution and control for a linear motor can be utilized, the explanation thereof is omitted here.

FIG. 7 is a schematic diagram wherein through forming a linear motor pair by combining two sets of linear motors each having a movable body as shown in FIG. 6 a driving device in x axis direction is constituted. The linear motor pair is disposed in a mirror symmetry with reference to the center plane 20 of the linear motor pair. When assuming one linear motor in the pair is as a first linear motor and the other as a second linear motor, the direction of the polarity of the permanent magnets 1 contained in the movable body of the second linear motor is set as that when the permanent magnets contained in the movable body of the first linear motor are displaced in parallel. Namely, the N pole and S pole of the permanent magnets 1 are disposed so as to face each other even between the two sets of the linear motors.

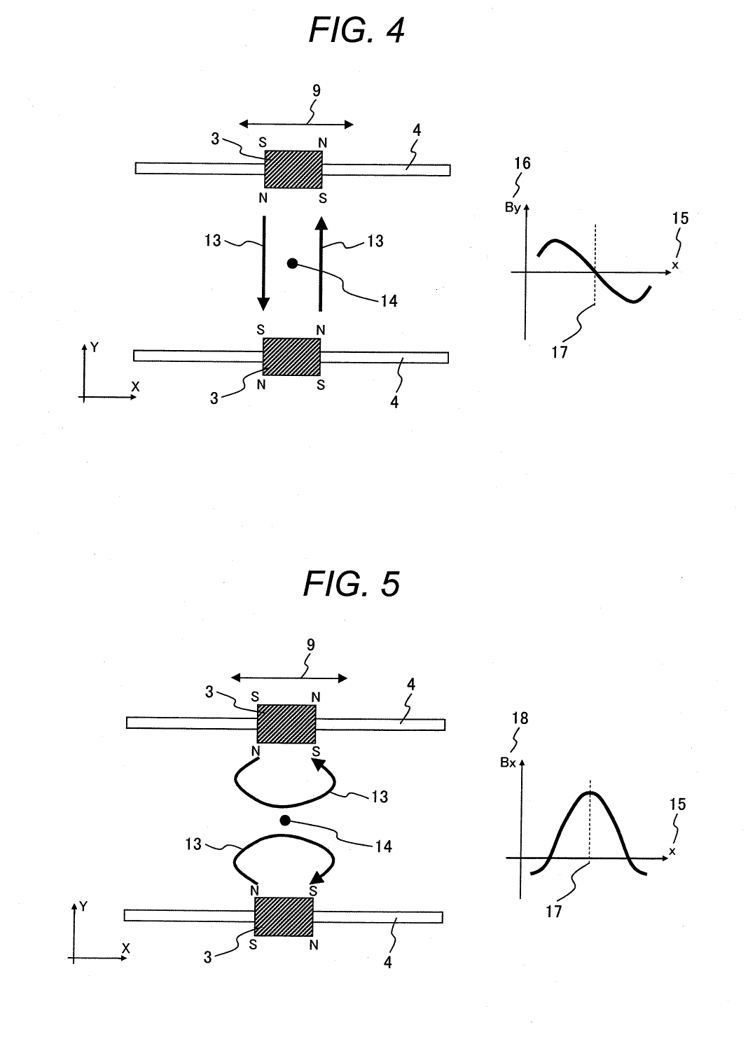

Through the arrangement of the linear motor pair as above, the direction of magnetic fluxes 13 are unified so as to direct from one movable body to the other movable body. Accordingly, a sign of magnetic field strength 16 in y direction at a magnetic field evaluation point 14 assumes one of plus and minus (minus in the case of FIG. 7), and is never split into plus and minus as in the case of FIG. 4. In addition, the x component of magnetic field at the magnetic field evaluation point 14 is cancelled out.

When two sets of the linear motor pairs as shown in FIG. 7 are arranged as in FIG. 2, an x y stage can be constituted of which magnetic field variation caused in association with the position change of the moving stage 5 is limited. Namely, a work region for electron beams and the like is formed at a region defined by the respective stationary bodies for the two sets of linear motor pairs.

As will be seen from the above, a possible magnetic field variation at the middle point of the linear motor pair caused in association with the movement of the movable bodies can be suppressed. Accordingly, when such linear motor pair is used, such as a stage driving device and an electron microscope of which magnetic field variation caused in association with the movement of the stage is limited can be realized. Further, since the amount of magnetic fluxes at the center of symmetry within the movable body is limited, the yoke portion can be modified to be thinned, thereby, weight lightening of the movable body is achieved. Still further, since the moving magnet type linear motor is employed, a possible dust caused in association with the movement of the movable body can be suppressed, which is advantageous for precision mechanical equipment such as an electron microscope.

### Embodiment 2

Another embodiment according to the present invention will be explained primarily with regard to different points from the embodiment 1 with reference to the drawings.

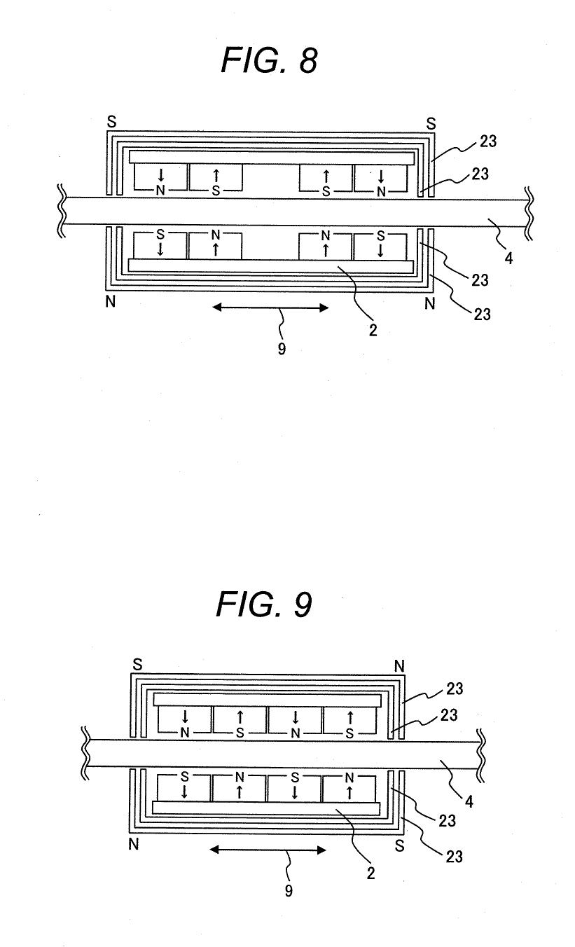

FIG. 8 shows a cross sectional view of a movable body in embodiment 2. Since magnetic shields 23 consisting of such as iron-nickel alloy plate having a large permeability are arranged so as to surround the yoke 2 and are fixedly secured to the movable body 3, a possible leakage of magnetic field from the movable body 3 can be reduced. Although the two layer structure of the magnetic shields 23 is shown in the present embodiment, the number of layers and the shape of the magnetic shield 23 are not restricted to that of the embodiment.

A comparison is shown in FIG. 9. The present comparison is an example for comparing with embodiment 2 as shown in FIG. 8. Since the arrangement of permanent magnets in the present comparison is different from that in embodiment 2, the length of the yoke 2 and the magnetic shields 23 in the moving direction of the movable body is shorter than that in embodiment 2, however, other sizes and the material characteristics are set equal.

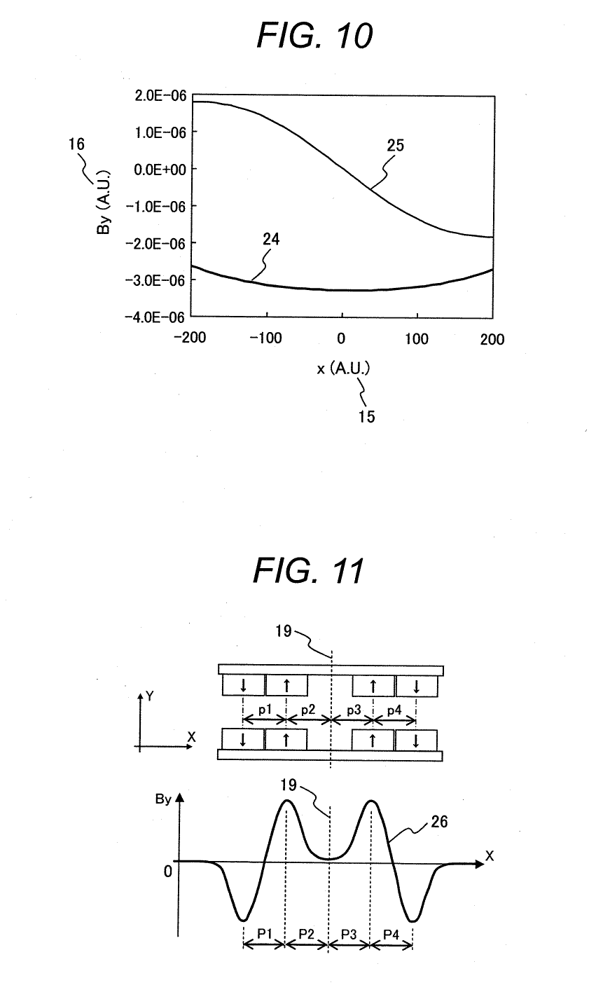

In FIG. 10, respective magnetic field distributions in embodiment 2 and the comparison are shown, in a case when respective driving devices in x axis direction are constituted by the respective linear motor pairs. The manners of constructing the linear motor pairs are based on FIG. 7 with regard to embodiment 2 and based on FIG. 4 with regard to the comparison respectively. These magnetic field distributions were obtained by simulation. The abscissa represents x coordinate 15 of the movable body, and the ordinate represents magnetic field strength 16 in y direction at the magnetic field evaluation point. The position of the magnetic field evaluation point 14 is defined as at the center of the movable body stroke (x=0) with regard to x position, an equidistance point from the two sets of linear motors with regard to y position and a certain position above from the upper face of the movable body with regard to z position. It was found out that the magnitude of the magnetic field variation in embodiment 2 is suppressed by an order of one digit in comparison with that in the comparison.

Further, with regard to magnetic field distribution in embodiment 2, the magnetic field strength 16 in y direction at the magnetic field evaluation point begins to vary at portions where the absolute value of x coordinate 15 for the movable body is large. In order to temper this variation and to prolong the stroke length that limits the magnetic field variation, it is sufficient if such as the length in moving direction of the movable body 3 and the number of permanent magnets are adjusted.

### Embodiment 3

In FIG. 11, the cross sectional view of the movable body as shown in connection with embodiment 1 and a magnetic flux density distribution in the gap between the permanent magnets are shown. When adjusting a thrust force of a linear motor, the magnetic flux density distribution in the gap is set to be in equal pitch. However, in the case of the magnet arrangement shown in the present embodiment, the magnetic flux density 26 in the gap gives zero at the center of the moving body as shown in FIG. 11. Accordingly, while assuming the magnetic flux density at the center of the movable body as one of local maximum points, it is sufficient if the permanent magnet pitches from p1 to p4 are adjusted so that the distances between the local maximum points from P1 to P4 become equal.

### Embodiment 4

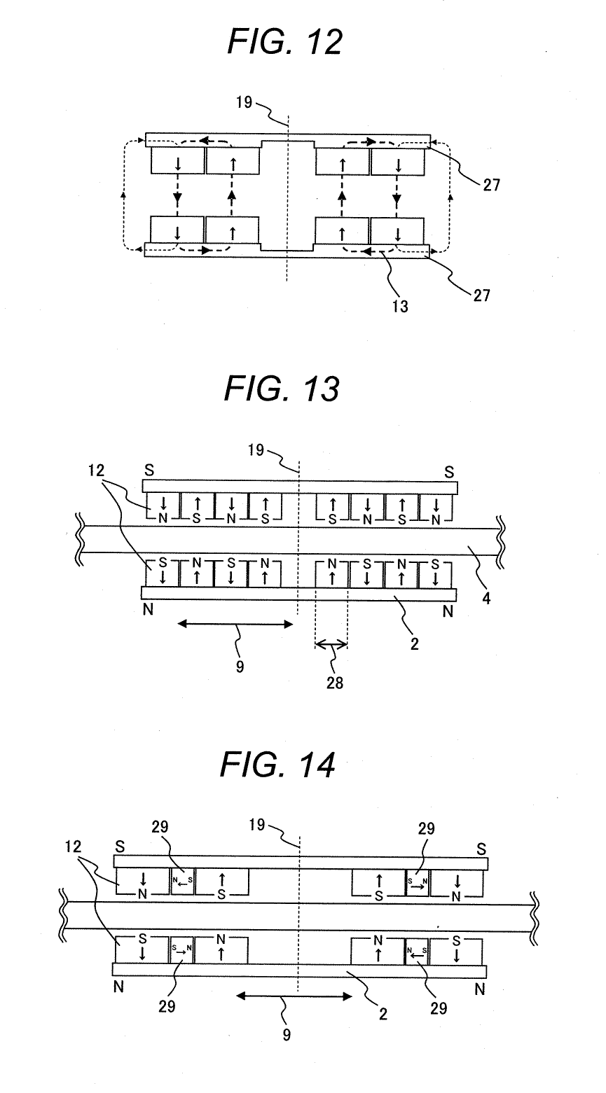

In FIG. 12, the cross sectional view of the movable body as shown in connection with embodiment 4 and an outline of magnetic flux distribution therein are shown. Since the magnetic fluxes 13 are not concentrated at the yoke near the center of the movable body due to the symmetric nature thereof, it is possible to reduce the mass of the yoke. For example, it is possible to use a weight lightened yoke 27 formed by shaving the yoke near at the center of the movable body. However, the weight lightened yoke 27 is required to keep the symmetric configuration.

### Embodiment 5

Since the magnetic flux density in the gap is zero at the center of the movable body as shown in FIG. 11, no thrust force cannot be generated in this range. Accordingly, when straightening of thrust force distribution of the movable body is required with respect to the moving direction 9 of the movable body, the length 28 of the permanent magnets in the moving direction of the movable body is shortened so as to reduce the permanent magnet pitch as shown in FIG. 13, thereby, the influence of the center portion of the movable body can be reduced relatively.

### Embodiment 6

A method of applying the Halbach array for permanent magnets has been known as one of methods for adjusting magnetic flux density distribution in the gap of the movable body. The Halbach array can also be applicable for the present invention, and, for example, it is sufficient if the permanent magnets 29 used for the Halbach array are disposed as shown in FIG. 14.

### EXPLANATION OF REFERENCE NUMERALS

1 . . . Permanent magnet,
2 . . . Yoke,
3 . . . Movable body,
4 . . . Stationary body,
5 . . . Moving stage,
6 . . . Coupling portion,
7 . . . Supporting device,
8 . . . Electron beam position,
9 . . . Movable body moving direction,
10 . . . Downward directing permanent magnet,
11 . . . Upward directing Permanent magnet,
12 . . . Magnet pair,
13 . . . Magnetic flux,
14 . . . Magnetic field evaluation point,
15 . . . x coordinate of movable body,
16 . . . Magnetic field strength in y direction at magnetic field evaluation point,
17 . . . x coordinate of movable body when magnetic field evaluation point positions at front face of movable body,
18 . . . Magnetic field strength in x direction at magnetic field evaluation point,
19 . . . Center plane of movable body,
20 . . . Center plane of linear motor pair,
21 . . . First linear motor,
22 . . . Second linear motor,
23 . . . Magnetic shield,
24 . . . Magnetic field distribution in embodiment 2,
25 . . . Magnetic field distribution in comparison,
26 . . . Magnetic flux density in gap,
27 . . . Weight lightened yoke,
28 . . . Length of permanent magnet in moving direction of movable body,
29 . . . Permanent magnet used for Halbach array,
p1, p2, p3, p4 . . . Permanent magnet pitch and
P1, P2, P3, P4 . . . Distance between magnetic flux density local maximum points.

What we claim is:

1. A linear motor pair including a first and second linear motor in which straight line shaped stationary bodies are disposed in parallel and each movable body moves in parallel therewith, characterized in that the movable body comprises 4N sets (N is a natural number) of magnet pairs that are disposed in a manner so that an N pole thereof faces a S pole thereof while sandwiching the stationary body, and the 4N sets of magnet pairs are disposed in mirror symmetry with reference to the center portion in the moving direction of the movable body as well as the magnet pairs are arranged in such a manner that the polarity of adjoining magnets at the center portion in the moving direction is set same and the polarity of the magnets is set to alternate as in N pole and S pole according to when the position of the magnet pairs moves away from the center portion.

2. A linear motor pair according to claim 1, characterized in that the first and the second linear motor are disposed in mirror symmetry being spaced apart with a predetermined interval so that their respective stationary bodies run in parallel, and the polarities of the magnetic poles of the 4N sets of magnetic pairs constituting the movable body for the respective linear motors are arranged so that if the both movable bodies are overlapped the polarities of the magnetic poles thereof coincide each other.

3. A linear motor pair according to claim 1, characterized in that the 4N sets of magnetic pairs constituting the movable body for the respective linear motors are arranged with a predetermined pitch except for the interval of the adjoining magnet pair at the center portion in the moving direction of the movable body, and the interval of the adjoining magnet pair at the center portion in the moving direction of the movable body is set at about two times of the predetermined pitch.

4. A linear motor pair according to claim 1, characterized in that the 4N sets of magnetic pairs and a yoke constituting the movable body for the respective linear motors are constituted surrounded by a magnetic shield.

5. A moving stage, characterized in that the movable body constituting the linear motor pair according to claim 1 is coupled to the moving stage via a coupling member, and the position in uniaxial direction of the moving stage is controlled by controlling the position of the movable body.

6. A moving stage, characterized in that the moving stage comprises at least two sets of the linear motor pairs according to claim 1, straight line shaped stationary bodies constituting the respective two sets of the linear motor pairs are arranged in directions crossing perpendicularly each other, the movable bodies of the two sets of linear motor pairs are coupled to the moving stage, and the position in biaxial direction of the moving stage is controlled by controlling the position of the respective movable bodies.

7. An electron microscope using th moving stage according to claim 6, characterized in that an electron beam irradiation region of the electron microscope is formed in a region surrounded by stationary bodies for the first and the second linear motor respectively constituting the two sets of linear motor pairs crossing perpendicularly each other.
